(19) United States
(12) Patent Application Publication
(10) Pub. No.: US 2006/0087154 A1
(43) Pub. Date: Apr. 27, 2006

(54) Cab platform floor adjustment system

(75) Inventors: Steffen Schlafer, Schifferstadt (DE); Jorg J. Hofle, Seeheim-Jugenheim (DE)

Correspondence Address: DEERE & COMPANY, ONE JOHN DEERE PLACE, MOLINE, IL, 61265, US

(73) Assignee: Deere & Company, a Delaware corporation

(21) Appl. No.: 11/253,120

(22) Filed: Oct. 18, 2005

(30) Foreign Application Priority Data
Oct. 21, 2004 (DE) 10 2004 051 256.6

(51) Int. Cl. B62D 33/06

(52) U.S. Cl. 296/190.01

(57) ABSTRACT

An adjustment system adjust the position of a platform of a cab of an agricultural or industrial utility vehicle. The platform includes an operator's seat, at least one pedal, a platform floor and a steering wheel. The adjusment system includes a mechanism which can adjust the position (height) of a portion of the platform floor independently of the position of the operator's seat. The platform floor portion extends at least between the seat and the pedal.

### BACKGROUND

The present invention relates to an adjustment mechanism for adjusting the position of a portion of the floor of a cab platform for a vehicle such as an agricultural or industrial utility vehicle. The vehicle platform includes an operator's seat, at least one pedal, a cab floor and a steering wheel.

A vehicle platform includes a group of vehicle components on which an operator of the vehicle is located during the operation of the vehicle. Tractors of the lower power class or of the lower price segment, in particular, are provided with open vehicle platforms, where the concept “open platform” is understood to mean, in particular, not a complete vehicle cab with cab posts, a cab roof and a corresponding glazed enclosure. Thus, the present invention is particularly applicable to vehicle cabs, where a vehicle cab generally is provided with a vehicle platform with cab posts, cab roof and a corresponding glazed enclosure.

Adjustment mechanisms of the aforementioned kind have long been known from the state of the art. Usually, the operator's seat can be adjusted vertically and/or horizontally in a vehicle so that the immediate position of the operator can be made to conform to the operator's body size or body mass relative to the component groups that are to be operated by the operator, for example, pedals or steering wheel. It is also known to adjust the steering column together with the steering wheel through an angle and/or to telescope these. The pedals in the vehicle or in a vehicle cab may also be arranged so that they can be adjusted in their position. For this purpose reference is made purely as an example to DE 198 51 468 A1 or DE 199 52 236 A1.

Normally, in agricultural utility vehicles such as tractors, an operator's seat is adjusted vertically and/or horizontally, and the position of the steering column is adjusted so as to pivot and/or to be telescoped. Usually the pedals and/or the instruments are stationary relative to the vehicle platform. Accordingly, an operator has only one seat position in the vehicle that is optimum for the operator and therefore ergonomic. This seat position depends, in particular, on the ability of the operator to reach the pedals with his feet. Accordingly, the operator will initially adjust the position of the operator's seat. Then the operator will normally adjust the position of the steering column to the position of the operator's seat. If only the operator's seat can be adjusted and/or the steering column cannot be adjusted, in many cases a seat position can be found that represents a compromise regarding the ability of the operator to reach the pedals and the steering wheel. This choice of seat position depends solely on the body mass of the operator and does not permit any possibility of variation to the operator. There is the possibility that an operator will not find an ergonomic seat position. This seat position is uncomfortable or is less than desirable in regard to the operator's health or safety.

### SUMMARY

Accordingly, an object of this invention is to provide an adjustment mechanism by means of which the aforementioned problems are overcome.

A further object of the invention is to provide such an adjustment mechanism which makes several ergonomic seat positions available to a vehicle operator.

These and other objects are achieved by the present invention, wherein an adjustment mechanism adjusts the height of a vehicle platform or cab floor portion independently of the position of the operator's seat. The platform floor or cab floor portion extends at least between the operator's seat and a pedal.

Such an adjustment mechanism makes it possible to vary a reference position of an operator on a vehicle platform or in a vehicle cab, independently of the position of the steering wheel, the pedals and/or the operator's seat. Accordingly, an operator can find not only one, but many optimum seat positions. Thereby, a nearly optimal seat position can be found and selected for the operator, not only as a function of the operator's body mass. The additional degrees of freedom can be utilized in a particularly advantageous way to find an optimum seat position for a particular or a planned operating mode of the vehicle. In particular, it is possible to adjust the seat position for agricultural utility vehicles for the particular operation that is to be performed. In that way, for example, for front loader operation it may definitely be useful for the operator to sit further forward on the vehicle platform and, if necessary, to sit at a lower level. On the other hand, it may be advantageous when a plow is coupled to the vehicle and during the plowing to sit at a higher level and more to the rear on the vehicle platform. During operation on public roads the highest possible seat position could be preferred, for optimum visibility. Therefore, the adjustment mechanism can provide an optimum seat position with optimized ergonomics as a function of the immediate operating mode of the vehicle.

Preferably, the platform floor portion can be adjusted from a lower position to a maximum upper position in a continuous motion. In the lower position the platform floor region can come into contact with the remaining platform floor at least in certain areas.

The mechanism may include a parallelogram lift mechanism or an expanding linkage lift mechanism. The parallelogram lift mechanism or the expanding linkage lift mechanism would be attached to the floor of the platform or to the vehicle frame, and to the platform floor portion.

Preferably, the platform floor portion is configured to prevent injury to an operator, such as by crushing. Also, seals could be provided to prevent intrusion of dirt. Preferably, the platform floor portion is configured in the form of a box or at least a box shape closed in the direction of the operator.

Preferably, the adjustment mechanism allows the height of the platform floor portion to be adjusted independently of the position of the steering wheel, the position of the operator's seat and/or the position of the pedals. In other words, it is possible to adjust the position of the platform floor portion alone without any adjustment of the position of other elements or groups of components of the vehicle platform.

With such a system, different operators can find or readjust, as rapidly as possible, the seat position optimized for him individually and/or for a particular operating mode of the utility vehicle. For this purpose a memory system could be provided in which differing adjustments of at least the adjustment mechanism could be stored. These differing individual adjustments could be provided as input, for example, by an input unit and stored in a memory or recalled again from the memory. For this purpose it is necessary that the individual groups of components of the vehicle platform can be adjusted by means of actuators and, for example, by actuation of corresponding operating elements on the vehicle platform. Furthermore, each of the groups of components or their actuators must be provided with a position sensor, which detects the actual position of the group of components and supplies it to the memory system. As soon as an operator has made the individual groups of components, for example, the position of the operator's seat, the platform floor region and the steering column conform optimally to his requirements, these adjustments could be stored by actuating a corresponding key in the memory system. At a later time or upon a renewed use of the vehicle the adjustment that was stored in memory could be recalled by actuating a further corresponding key and again adjusted by the actuators. But this adjustment could be overridden by a manual input deviating from the above.

Moreover, the body size of an operator could be used as an input. From this input adjustments could be provided as selections that could be chosen by the operator from a display of the platform floor portion, from which the operator selects an adjustment and whereupon the platform floor portion conforms to this selection. In that way an operator who uses the vehicle for the first time can be offered to great advantage a selection of a position that is optimal for him. An immediate adjustment of the platform floor region after the input of the body size could also be provided, so that the offering of possible adjustments can be omitted.

Moreover, positions of the adjustment mechanism could be stored in the memory system or determined for various operating modes. A desired operating mode of the utility vehicle could be provided as input by the operator by means of an input device. Then, at least the platform floor portion could occupy a position optimized or selected for the operating mode input. Thereby too, the finding of an optimal adjustment for the individual groups of components for an intended operating mode could be simplified in a very particularly advantageous manner. Possible operating modes of an agricultural or industrial utility vehicle could include, for example, operation on public roads, the performance of front loader operations or operation on a field.

Preferably, adjustment of the height of the platform floor portion is prevented during an operating mode of the vehicle, such as operation on public roads. Thereby, preventing unintended actuation of an operating element of the adjustment mechanism during the operation on public roads.

Preferably, a control unit or system is provided for the adjustment mechanism. This is required particularly when several groups of components are arranged on the adjustable vehicle floor platform. In that way, for example, the pedals as well as the platform floor region could each be readjusted in their position, independently of each other. In that way, for example, the pedals as well as the platform floor region could each be readjusted independently of each other. Situations could occur in which the platform floor portion has not yet reached its uppermost position, but however, on the basis of the actual existing adjustment of the pedals the platform floor portion cannot be moved upward any further without coming into contact with the pedals or without allowing sufficient free space for the actuation of the pedals. Correspondingly, all possible positions of the individual groups of components of the vehicle platform that can be adjusted can be stored in the memory arrangement, for example, by storing each of the adjustment regions of the groups of components that are arranged to be adjustable together with their external dimensions.

Preferably, an operator is provided with as many degrees of freedom as possible for the adjustment of the operator's seat, or the operating position on the platform or in the cab. For this purpose, individual components or several groups of components of the vehicle platform could also be arranged to be adjustable. For example, at least one pedal could be arranged to be adjustable in its position in the vertical and/or horizontal direction. This could be performed, for example, by a double parallelogram steering arm guidance arrangement or by a linear guidance arrangement. Moreover, the steering wheel could be guided by a steering column or the steering column could be arranged as telescoping and/or so as to pivot in at least one plane for the adjustment of its position. Alternatively, or in addition, the operator's seat could be adjustable in the vertical and/or horizontal direction. Ideally, the adjustable component components can be continuously adjustable in their positions so that all possible intermediate positions are available to an operator.

The pedal, the steering column and/or the operator's seat, (each or all of them) can preferably be adjusted continuously and driven mechanically or electrically. A hydraulic or pneumatic adjustment of the groups of components is also possible using common, commercially available actuators. Preferably, at least one actuator has a position sensor, so that the actual adjusted position of a group of components can be determined from the actual position of the actuator and stored in a memory unit or checked for reasonableness by a control unit. The latter is required in particular if the positions of the pedals as well as the steering column, the operator's seat and the platform floor region can each be adjusted independently of each other. As already indicated above, situations can occur in which, for example, the platform floor region is not yet in its uppermost position but it cannot be moved upward on the basis of the actual adjustment position of the pedals without coming into contact with the pedals.

### BRIEF DESCRIPTION OF THE DRAWINGS

FIG. 1 is a side view of a vehicle platform and the individual components thereof.

FIG. 2 is a side view of an embodiment according to the present invention.

### DETAILED DESCRIPTION

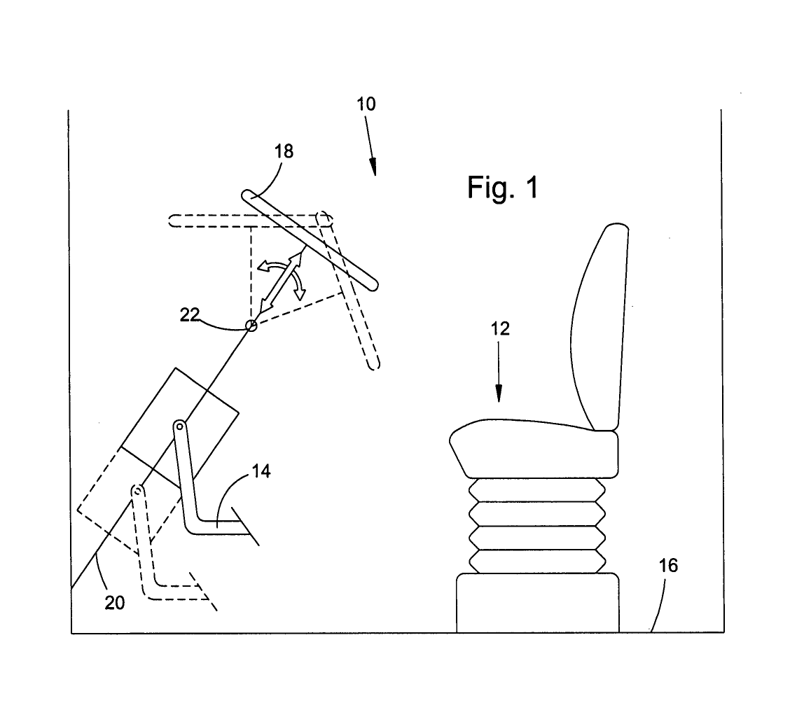

Referring to FIG. 1, a part of a vehicle platform 10 includes an operator's seat 12, pedals 14, a platform floor 16 and a steering wheel 18. The operator's seat 12 can be variably adjusted in height relative to the platform floor 16. The pedals 14, of which only one can be seen in FIG. 1, can also be variably adjusted in their position relative to the platform floor 16, such as along the longitudinal axis of the steering shaft 20, as shown by the dashed lines. Preferably, the steering wheel 18 is arranged so as to telescope along the direction of the steering shaft 20, and is also arranged to pivot about the pivot point 22, and thereby can be variably adjusted in various positions, as shown in dashed lines. The steering wheel 18 can also be telescoped as is indicated by the arrow along the axis of the steering shaft 20.

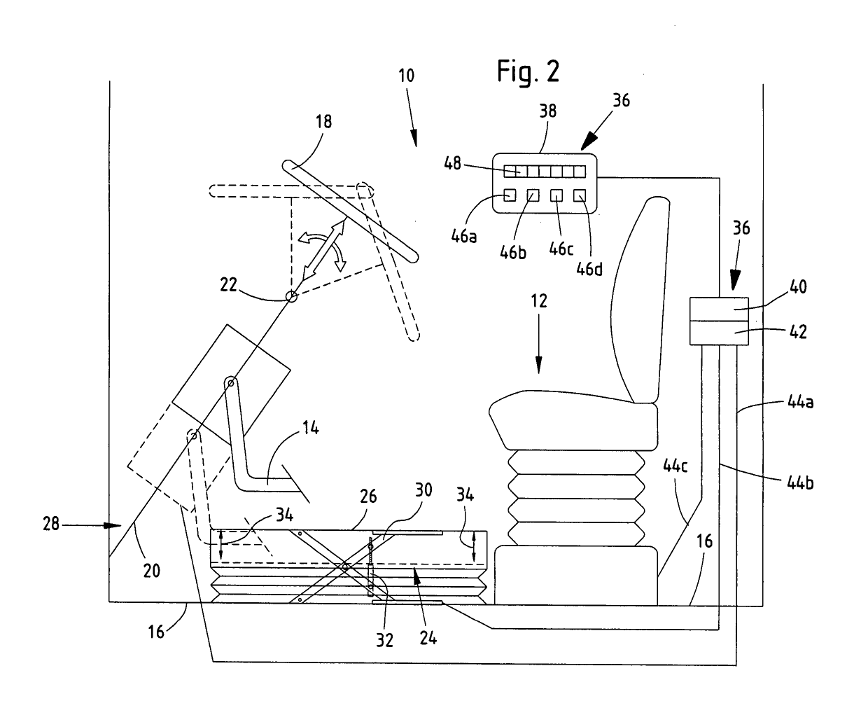

Referring to FIG. 2, a section of a vehicle cab 10 that is provided with an adjustment mechanism 24. The vehicle cab 10 includes a vehicle platform with a platform floor 16. The vehicle cab 10 also contains an operator's seat 12, several pedals 14 and a steering wheel 18. All these groups of components can be adjusted in their positions relative to the vehicle cab 10 or the cab floor 16, similar to the same groups of components as those shown in FIG. 1.

The adjustment mechanism 24 operates to adjust the height of the cab floor portion 26 continuously relative to the cab floor 16. The cab floor portion 26 is configured in a box shape and extends between the operator's seat 12 and up to the pedals 14 or almost to the steering column structure 28.

Preferably, cab floor portion 26 is configured so that it cannot cause injury to an operator. In particular, no intervening spaces are provided between the vehicle cab 10 and the cab floor portion 26 in which, for example, a foot of an operator could become trapped during a height adjustment of the cab floor portion 26. Furthermore, the cab floor portion 26 is preferably operated so that during a motorized adjustment in height, the adjustment is stopped automatically if a force applied during the height adjustment of the cab floor portion 26 exceeds a predetermined value. In this way an unintended crushing of or an injury to the foot of an operator can be avoided.

The cab floor portion 26 can be adjusted in height by itself, in other words completely independently of any adjustment, for example, the horizontal and/or vertical position of the operator's seat 12, the position of the pedals 14 or the steering wheel 18.

The height of the cab floor portion 26 can be adjusted by an expanding linkage lift mechanism 30. The expanding linkage lift mechanism 30 is adjusted by an actuator 32 that is driven by an electric motor, so that the cab floor portion 26 can be adjusted in height in the direction of the double arrows 34. A further lowered position for the cab floor portion 26 is in dashed lines.

With such a system, different operators can find or readjust, as rapidly as possible, the seat position optimized for him individually and/or for a particular operating mode of the utility vehicle. For this purpose a memory system 36 could be provided in which differing adjustments of at least the adjustment mechanism could be stored. These differing individual adjustments could be input into an input unit 38 and stored in a memory 40 or recalled again from the memory 40. For this purpose it is necessary that the individual groups of components of the vehicle platform 10 can be adjusted by a control unit 42 and by means of control lines 44a, 44b and 44c to actuators (not shown) and, for example, by actuation of corresponding operating elements on the vehicle platform 10. Furthermore, each of the groups of components or their actuators must be provided with a position sensor (not shown), which detects the actual position of the group of components and supplies it—via the lines 44a, 44b and 44c—to the memory system 40 and to the control unit 42. As ®soon as an operator has made the individual groups of components, for example, the position of the operator's seat 12, the platform floor region 26 and the steering column 28 conform optimally to his requirements, these adjustments could be stored by actuating a corresponding key 46a, to 46d in the memory system 40. At a later time or upon a renewed use of the vehicle the adjustment that was stored in memory 40 could be recalled by actuating a further corresponding key 46a, to 46d and again adjusted by the actuators. But this adjustment could be overridden by a manual input deviating from the above.

Moreover, the body size of an operator could be used as an input. From this input adjustments could be provided as selections that could be chosen by the operator from a display 48 of the platform floor portion 26, from which the operator selects an adjustment and whereupon the platform floor portion 26 conforms to this selection. In that way an operator who uses the vehicle for the first time can be offered to great advantage a selection of a position that is optimal for him. An immediate adjustment of the platform floor region 26 after the input of the body size could also be provided, so that the offering of possible adjustments can be omitted.

Moreover, positions of the adjustment mechanism could be stored in the memory system 40 or determined for various operating modes. A desired operating mode of the utility vehicle could be provided as input by the operator by means of an input device 38. Then, at least the platform floor portion 26 could occupy a position optimized or selected for the operating mode input. Thereby too, the finding of an optimal adjustment for the individual groups of components for an intended operating mode could be simplified in a very particularly advantageous manner. Possible operating modes of an agricultural or industrial utility vehicle could include, for example, operation on public roads, the performance of front loader operations or operation on a field.

Preferably, adjustment of the height of the platform floor portion 26 is prevented during an operating mode of the vehicle, such as operation on public roads. Thereby, preventing unintended actuation of an operating element of the adjustment mechanism during the operation on public roads.

Preferably, a control unit 42 or system is provided for the adjustment mechanism. This is required particularly when several groups of components are arranged on the adjustable vehicle floor platform. In that way, for example, the pedals 14 as well as the platform floor region 26 could each be readjusted in their position, independently of each other. In that way, for example, the pedals 14 as well as the platform floor region 26 could each be readjusted independently of each other, e.g. via the lines 44a, 44b and 44c. Situations could occur in which the platform floor portion 26 has not yet reached its uppermost position, but however, on the basis of the actual existing adjustment of the pedals 14 the platform floor portion 26 cannot be moved upward any further without coming into contact with the pedals 14 or without allowing sufficient free space for the actuation of the pedals 14. Correspondingly, all possible positions of the individual groups of components of the vehicle platform 10 that can be adjusted can be stored in the memory arrangement 40, for example, by storing each of the adjustment regions of the groups of components that are arranged to be adjustable together with their external dimensions.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. An adjustment system for a platform of a cab of a utility vehicle, the platform (10) having an operator's seat (12), a pedal (14), a platform floor (16) and a steering wheel (18), characterized by:
an adjusting mechanism for adjusting a height of a portion of the platform floor (26) independently of a position of the operator's seat (12), and said portion of the platform floor extending between the operator's seat (12) and the pedal (14).

2. The adjustment system of claim 1, wherein:
the adjusting mechanism adjusts the height of the portion of the platform floor (26) from a lower position into a maximum upper position in a continuous motion.

3. The adjustment system of claim 1, wherein:
the adjusting mechanism comprises a parallelogram lift mechanism.

4. The adjustment system of claim 1, wherein:
said portion of the platform floor (26) has a box shaped configuration which is closed to an interior of the vehicle cab.

5. The adjustment system of claim 1, wherein:
the adjusting mechanism adjusts the height of the portion of the platform floor (26) independently of the steering wheel, the position of the operator's seat and the position of the pedals.

6. The adjustment system of claim 1, further comprising:
a memory system in which various conditions of the adjusting mechanism be stored in memory by an input unit, said conditions being optimized for an individual operator and for a particular operating mode of the utility vehicle; and
a control unit for controlling the adjustment mechanism as a function of the stored conditions.

7. The adjustment system of claim 6, further comprising:
a display unit for displaying adjustment choices to an operator; and
the input unit inputs a body size of an operator, and the display unit is operable by the operator to select one of the adjustment choices on the display for the adjustment of the platform floor portion (26).

8. The adjustment system of claim 6, wherein:
the memory system stores adjustment positions for various different stored vehicle operating modes; and
a display unit and an input unit are operable by the operator to select one of the stored operating modes, and the adjustment mechanism moving the platform floor portion to a position optimized or selected for the operating mode.

9. The adjustment system of claim 8, wherein:
the operating modes comprise operation on public roads, front loader operation and field operation.

10. The adjustment system of claim 6, wherein:
the control unit prevents operation of the adjustment mechanism when the vehicle is operating on a public road.

11. The adjustment system of claim 6, wherein:
the control unit checks for reasonableness the operation of the adjustment mechanism.

12. The platform of claim 1, wherein:
the pedal is adjustable in its position.

13. The platform of claim 1, wherein:
the steering wheel is supported by a steering column which can be telescoped, and the steering wheel is pivotal in at least one plane.

14. The platform of claim 1, wherein:
the operator's seat is adjustable in its position.

15. The platform of claim 1, wherein:
a pedal, the steering column and the operator's seat are movable in a continuous motion.

16. The platform of claim 1, wherein:
the adjusting mechanism comprises an expanding linkage lift mechanism.
